(19) United States
(12) Patent Application Publication
(10) Pub. No.: US 2022/0356757 A1
(43) Pub. Date: Nov. 10, 2022

(54) MAGNETIC SCREEN WITH SOLID PANEL

(71) Applicant: Breakthrough Premium Products Inc., Guelph (CA)

(72) Inventor: ALEX MITCHELL, GUELPH (CA)

(21) Appl. No.: 17/677,988

(22) Filed: Feb. 22, 2022

Related U.S. Application Data
(60) Provisional application No. 63/185,918, filed on May 7, 2021.

(51) Int. Cl. E06B 9/52; E06B 7/32

(52) U.S. Cl. CPC E06B 9/521; E06B 7/32; E06B 2009/524; E06B 2009/527; E06B 2009/528

(57) ABSTRACT

A magnetic screen door includes a solid section in a screen to protect the screen from damage as users pass through the screen. In some embodiments, the apparatus includes a first and second panel each comprising a flexible mesh section, an inside lateral edge and an outside lateral edge. A magnetic element may be coupled to the inside lateral edges. One or both panels may include a solid inset. The apparatus also comprises a second panel. In an illustrative use, as an animal presses on the solid inset, the first and second panels separate to allow the animal through. The flexible mesh section is protected from damage since the animal makes contact with the solid inset instead of the more fragile mesh section.

### CROSS-REFERENCE TO RELATED APPLICATIONS

This application claims benefit under 35 U.S.C. § 119(e) of U.S. Provisional Application having Ser. No. 63/185,918 filed May 7, 2021, which is hereby incorporated by reference herein in its entirety.

### FIELD

The subject disclosure relates to barriers, and more particularly, to a magnetic screen with solid panel.

### BACKGROUND

Magnetic screen doors are often used as a temporary barrier for a doorway while keeping a door open. The magnetic screen doors are generally made of breathable fabric so that pests are kept out of a room and while ventilation is allowed to pass into the room. The screen doors are designed for people to pass through easily without having to worry about opening and closing the screen door behind them. Some magnetic screen door owners are also pet owners and use a magnetic screen door as a pet door. However, it is common for pets to damage the screen mesh with their nails/claws when making contact with the screen to pass through.

As can be seen, there is a need for an improvement to magnetic screen doors that protect against damage when being passed through.

### SUMMARY

In one aspect of the disclosure, a magnetic screen apparatus for providing a passable barrier in an entryway is provided. The apparatus comprises a first panel. The first panel includes a first flexible mesh section, a first inside lateral edge and a first outside lateral edge, a first magnet or first magnetically attracted element coupled to the first inside lateral edge, and a first solid inset positioned on or coupled to the first flexible mesh section. The apparatus also comprises a second panel. The second panel includes: a second flexible mesh section, a second inside lateral edge and a second outside lateral edge, and a second magnet or second magnetically attracted element coupled to the second inside lateral edge. The first magnet or first magnetically attracted element is positioned on the first flexible mesh panel to magnetically attract to the second magnet or second magnetically attracted element on the second flexible mesh panel. The second panel also includes a second solid inset positioned on or coupled to the second flexible mesh section.

In another aspect, a screen apparatus for providing a passable barrier in an entryway is provided. The screen apparatus includes a left side portion including a left side screen section and a left side solid panel. The apparatus further includes a right side portion including a right side screen section and a right side solid panel. In addition, a releasable fastener couples the left side portion to the right side portion. The fastener is configured to open in response to an animal passing between the left side portion and the right side portion.

In still yet another aspect, a removable screen apparatus is provided. The apparatus includes a fabric perimeter configured for removable attachment to a doorway. The apparatus further includes a central, split seam. The central, split seam is positioned on a vertical line proximate a top edge of the perimeter to a bottom edge of the perimeter. A magnetic fastener is positioned on the central seam. An upper flexible screen area is divided laterally by the central seam. A solid, rigid area is positioned below the upper flexible screen area and divided by the central seam. In response to an animal pressing against the solid, rigid area and passing through the central seam, the magnetic fastener is configured to release a left side of the flexible screen area and a left side of the solid, rigid area from closure with a right side of the flexible screen area and a right side of the solid, rigid area.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a front view of a magnetic screen door in accordance with an aspect of the subject technology.

FIG. 2 is a front view of the magnetic screen door of FIG. 1 installed in a door entry frame in accordance with embodiments.

FIG. 3 is a front view of the magnetic screen door of FIG. 1 shown relative to a pet for an exemplary use application.

FIG. 4 is a front view of the magnetic screen door of FIG. 1 in use by a pet.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

In general, exemplary embodiments of the subject technology provide a barrier apparatus. In one embodiment, the apparatus is a magnetically clasped screen door. The door may be temporarily hung (removable) in a doorway to prevent pests from entering an area while letting air to flow through. Some embodiments may include more permanently attached screens to doorways or other frames. In general, embodiments include a screen area that has openings sufficient for airflow. Embodiments include a solid panel section that is sturdier than the screen section of the apparatus. An illustrative embodiment includes the solid section in a lower area of the screen panel(s) to protect the screen from damage as users pass through the screen. In an exemplary application, a magnetic screen door of the subject technology may be particularly useful when used with pets walking in through a doorway. As will be seen, the solid panel section protects the screen from damage that occurs from pets' claws/nails breaking up the magnetic seam of the magnetic screen. In an illustrative use, as an animal presses on the solid part of the apparatus, first and second panels separate to allow the animal through. The flexible mesh section is protected from damage since the animal makes contact with the solid part instead of the more fragile mesh section.

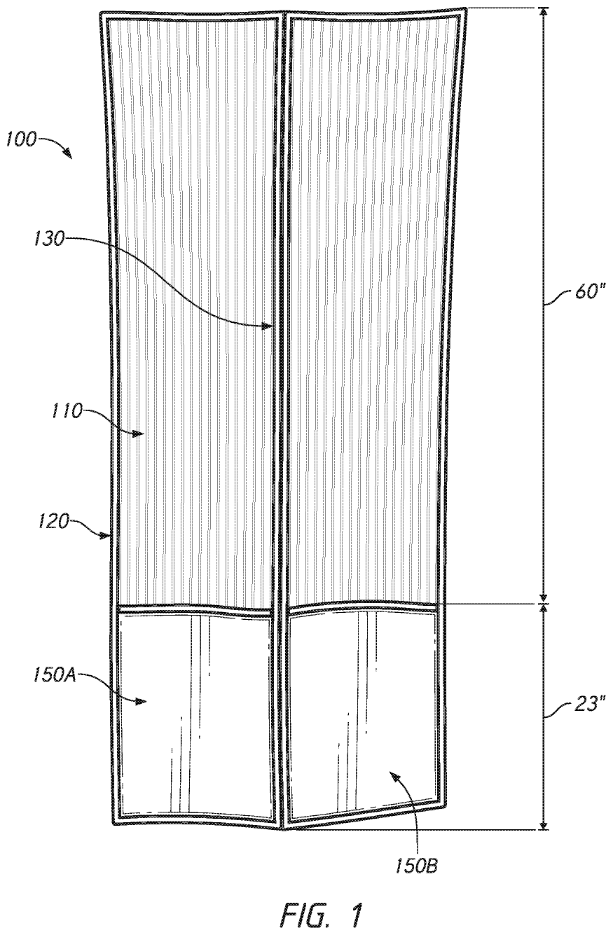

Referring now to FIG. 1, an apparatus 100 is shown according to an exemplary embodiment. The apparatus 100 may be for example, a screen door. Some embodiments of the screen door may include magnetically released screens. Thus, the apparatus 100 may be sometimes be referred to interchangeably throughout as the “magnetic screen door 100” or “screen door” for illustrative purposes. However other embodiments may vary from a magnetic screen door. For example, some embodiments may use releasable fasteners other than the magnetic type.

The apparatus 100 may include two halves of mesh screen panels 110. The mesh may be any flexible fabric with openings for airflow. In one example, the mesh is woven fiberglass. In an exemplary embodiment, the magnetic screen door 100 includes a solid panel section 150 on a lower half of the mesh area. In one embodiment, the solid panel 150 may be an inset of solid and rigid material that is positioned within the borders of the screen door 100. Generally, the material for the solid panel section 150 is heavier, more durable, and stiffer than the screen/mesh areas of the apparatus. The solid panel 150 may be a transparent or translucent lightweight material; for example, Polyethylene Terephthalate (PET). In some embodiments, the solid panel or inset 150 may be split so that each mesh panel half 110 has its own respective solid panel or inset 150A; 150B. In some embodiments, the solid panels or insets 150A; 150B are positioned adjacent, juxtaposed, or in lateral alignment to each other. In some embodiments, the solid panels or insets 150A; 150B may be on a lower half of the screen door area. In some embodiments, the solid panels or insets 150A; 150B may be positioned on a bottom edge of the screen door area. While the figures show the solid panels or insets 150A; 150B on the bottom edges, it will be understood that other embodiments may offset the solid panels or insets 150A; 150B from the bottom edge without departing from the scope of embodiments disclosed herein.

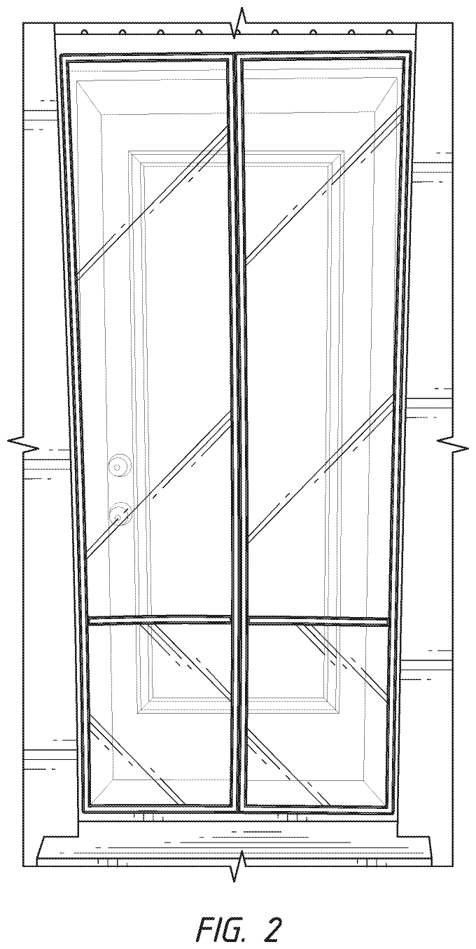

A fabric border 120 may line the perimeter of the screen door, a central seam 130, and around solid panel sections or inset 150A and 150B. The fabric border 120 may be a soft-sided hook and loop system sewn down both sides and top of the edge. The hook and loop system may be used to attach the screen door 100 to an existing door frame. See for example, FIG. 2. The central seam 130 may house a magnet(s) and defines the inner edge of respective mesh panels 110, which couple together to close the screen door 100 by attraction of the magnet(s). The central seam 130 may also be coupled to the solid panels or insets 150A;150B so that the panels or insets 150A;150B also form part of the closed screen when the magnet(s) are joined. Other embodiments may incorporate rigid perimeters instead of flexible, fabric borders. Other embodiments may be configured for permanent attachment to doorways or framing.

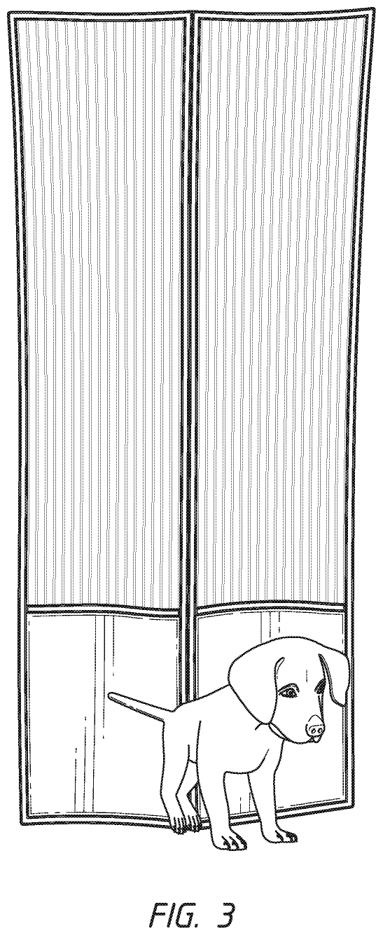

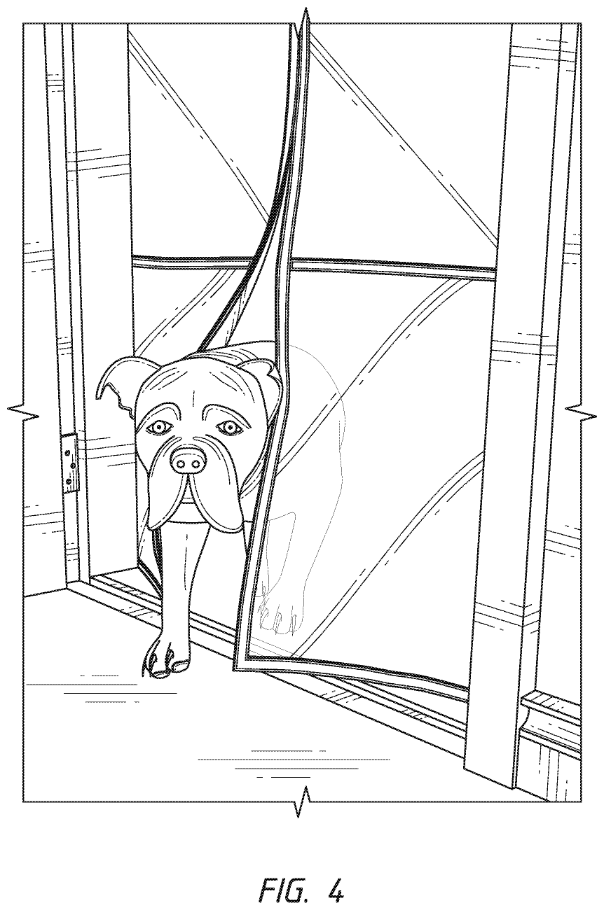

Referring now to FIGS. 3 and 4, in an exemplary use, the magnetic screen door 100 may be used by pets as well as people to pass through a doorway while preventing pests from passing through and permitting ventilation into a room. In use by an animal (for example, a dog or cat), the animal may push against one of the solid panel sections 150A; 150B to split open the central seam 130. See for example, FIG. 4. The solid panel sections 150A and 150B are sturdy enough to resist damage from an animal's nails/claws as the animal pushes through one of the panels 150A;150B leaving the mesh material on the remainder of the screen section free from contact damage.

As will be appreciated, the magnetic screen door 100 is designed for use with any doorway. This can be on a house, on a shed, on a trailer, on a cottage, on a greenhouse. Accordingly, while the figures may show an exemplary set of dimensions, the dimensions for embodiments may be modified to fit any particular doorway of need. In addition, while a PET type material has been disclosed for use with the solid panel 150, it will be apparent to those of ordinary skill in the art that other solid materials may be used without departing from the scope of the embodiments disclosed herein.

Those of skill in the art would appreciate that various components may be arranged differently (e.g., arranged in a different order, or partitioned in a different way) all without departing from the scope of the subject technology. For example, while the illustrative embodiments show an arrangement with the solid sections extending from one edge to another edge, some embodiments may use solid sections covering only partial areas between left and right edges of the screen door area or of respective panels.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

Terms such as “top,” “bottom,” “front,” “rear,” “above,” “below” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference. Similarly, an item disposed above another item may be located above or below the other item along a vertical, horizontal or diagonal direction; and an item disposed below another item may be located below or above the other item along a vertical, horizontal or diagonal direction.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A magnetic screen apparatus for providing a passable barrier in an entryway, comprising:
a first panel, including:
a first flexible mesh section,
a first inside lateral edge and a first outside lateral edge,
a first magnet or first magnetically attracted element coupled to the first inside lateral edge, and
a first solid inset positioned on or coupled to the first flexible mesh section; and
a second panel, including:
a second flexible mesh section,
a second inside lateral edge and a second outside lateral edge,
a second magnet or second magnetically attracted element coupled to the second inside lateral edge, wherein the first magnet or first magnetically attracted element is positioned on the first flexible mesh panel to magnetically attract to the second magnet or second magnetically attracted element on the second flexible mesh panel, and
a second solid inset positioned on or coupled to the second flexible mesh section.

2. The magnetic screen apparatus of claim 1, further comprising a first seam on the first inside lateral edge, wherein the first magnet or first magnetically attracted element is enclosed in the first seam, and a second seam on the second inside lateral edge, wherein the second magnet or second magnetically attracted element is enclosed in the second seam.

3. The magnetic screen apparatus of claim 1, wherein the first solid inset is transparent or translucent.

4. The magnetic screen apparatus of claim 1, wherein the first solid inset is plastic.

5. The magnetic screen apparatus of claim 1, wherein the first solid inset is positioned below the first flexible mesh section.

6. The magnetic screen apparatus of claim 1, wherein the first solid inset is positioned in alignment with the second solid inset.

7. The magnetic screen apparatus of claim 1, further comprising a flexible outer perimeter.

8. The magnetic screen apparatus of claim 1, wherein the first flexible mesh section is a fabric.

9. The magnetic screen apparatus of claim 8, wherein the fabric is a woven fiberglass.

10. The magnetic screen apparatus of claim 1, wherein the first solid inset moves away from the second solid inset in response to an animal passing between the first inside lateral edge and the second inside lateral edge.

11. The magnetic screen apparatus of claim 1, further comprising a hook and loop system.

12. A screen apparatus for providing a passable barrier in an entryway, comprising:
a left side portion including a left side screen section and a left side solid panel;
a right side portion including a right side screen section and a right side solid panel; and
a releasable fastener coupling the left side portion to the right side portion, wherein the fastener is configured to open in response to an animal passing between the left side portion and the right side portion.

13. The screen apparatus of claim 12, wherein the left side solid panel or the right side solid panel are rigid.

14. The screen apparatus of claim 12, wherein the left side solid panel and the right side solid panel are positioned below the left side screen section and the right side screen section respectively.

15. The screen apparatus of claim 12, wherein the left side solid panel and the right side solid panel are positioned on a lower half of the left side screen section and the right side screen section respectively.

16. The screen apparatus of claim 12, wherein the left side solid panel is aligned laterally to the right side solid panel.

17. The screen apparatus of claim 12, wherein the left side solid panel or the right side solid panel are transparent or translucent.

18. The screen apparatus of claim 12, wherein the releasable fastener comprises a magnet.

19. The screen apparatus of claim 12, wherein the left side solid panel or the right side solid panel are heavier than left side screen section or the right side screen section.

20. A removable screen apparatus, comprising:
a fabric perimeter configured for removable attachment to a doorway;
a central, split seam, wherein the central split seam is positioned on a vertical line proximate a top edge of the perimeter to a bottom edge of the perimeter;
a magnetic fastener positioned on the central seam;
an upper flexible screen area divided laterally by the central seam; and
a solid, rigid area positioned below the upper flexible screen area and divided by the central seam, wherein in response to an animal pressing against the solid, rigid area and passing through the central seam, the magnetic fastener is configured to release a left side of the flexible screen area and a left side of the solid, rigid area from closure with a right side of the flexible screen area and a right side of the solid, rigid area.
